(19) United States
(12) Patent Application Publication
(10) Pub. No.: US 2026/0142203 A1
(43) Pub. Date: May 21, 2026

(54) MEMBRANE-ELECTRODE ASSEMBLY HAVING A MOISTURE DISCHARGE STRUCTURE AND MANUFACTURING METHOD THEREOF

(71) Applicants: Hyundai Motor Company, Seoul (KR); Kia Corporation, Seoul (KR)

(72) Inventor: Woo Jin Lee, Hwaseong-si (KR)

(21) Appl. No.: 19/250,993

(22) Filed: Jun. 26, 2025

(30) Foreign Application Priority Data
Nov. 18, 2024 (KR) 10-2024-0164097

(51) Int. Cl. H01M 8/04119; G06T 7/00; H01M 8/0276; H01M 8/1004

(52) U.S. Cl. CPC H01M 8/04156; G06T 7/0004; H01M 8/0276; H01M 8/1004

(57) ABSTRACT

A membrane-electrode assembly is provided in which a moisture discharge port extends through a first sub-gasket and an electrolyte membrane, allowing efficient release of moisture and reducing the risk of blistering. The membrane is flanked by a first and second electrode, each in contact with a sub-gasket. Optionally, multiple moisture discharge ports are arranged in the membrane's width direction, and main gaskets with protrusions can help align these ports. A manufacturing process involves preparing a membrane-electrode stack, attaching the first sub-gasket, forming the discharge port by perforation, and then attaching the second sub-gasket. Additional steps may include using a carrier film for easier handling, applying roll presses with a shaped blade to create the ports, and inspecting port formation via a vision camera. This design helps prevent moisture build-up, mitigates blistering or delamination, and can enhance the overall performance and reliability of the fuel cell.

### CROSS-REFERENCE TO RELATED APPLICATION

This application claims, under 35 U.S.C. § 119(a), the benefit of Korean Patent Application No. 10-2024-0164097, filed on Nov. 18, 2024, the entire contents of which are incorporated herein by reference.

### BACKGROUND

### Technical Field

The present disclosure relates to a membrane-electrode assembly having a moisture discharge structure on one side and a method of manufacturing the same.

### Background

A membrane-electrode assembly is configured such that a cathode and an anode are located on respective sides of an electrolyte membrane. When air (oxygen) is supplied to the cathode side and hydrogen is supplied to the anode side, a voltage of about 1 V is formed. This voltage decreases due to various resistance components when current is drawn, and a cell voltage of about 0.6 V to 0.9 V is typically formed in the system.

Meanwhile, the flow of supplied gas and discharged moisture/gas has to be ensured to maintain the cell voltage at a normal level. If the gas and moisture passages are blocked, the cell voltage decreases, which causes stack deterioration.

Meanwhile, a membrane-electrode assembly that is mass-produced has a main structure in which a sub-gasket is attached to the outside of the membrane-electrode assembly with an adhesive. In order to impart physical rigidity to a CCM (catalyst coated membrane) configured such that electrodes are formed on the electrolyte membrane, a sub-gasket including a polymer film such as polyethylene terephthalate (PET), polyethylene naphthalate (PEN), polyethylene (PE), or polypropylene (PP) is bonded. The sub-gasket has a cut-out shape at the center thereof so that the electrodes are exposed to the outside. In the membrane-electrode assembly with the sub-gasket attached to both sides of the CCM, the portion where the electrolyte membrane and the sub-gasket are in contact with each other has a problem in that moisture transferred to the electrolyte membrane is sealed by the sub-gasket to thus form blisters inside, causing swelling of the adhesive or peeling of the adhesive or the sub-gasket from the electrolyte membrane.

### SUMMARY OF THE DISCLOSURE

Some embodiments of the present disclosure provide a membrane-electrode assembly capable of preventing defects caused by blistering by virtue of efficient discharge of moisture and a method of manufacturing the same.

Some embodiments of the present disclosure provide a membrane-electrode assembly capable of easily confirming whether the structure of a final product is properly formed and a method of manufacturing the same.

Some embodiments of the present disclosure provide a membrane-electrode assembly capable of preventing crossover and a method of manufacturing the same.

An example embodiment of the present disclosure provides a membrane-electrode assembly including an electrolyte membrane having a first side and a second side, a first electrode disposed on the first side of the electrolyte membrane, a second electrode disposed on the second side of the electrolyte membrane, a first sub-gasket disposed on the first side of the electrolyte membrane and in contact with an edge of the first electrode, a second sub-gasket disposed on the second side of the electrolyte membrane and in contact with an edge of the second electrode, and a moisture discharge port extending through the first sub-gasket and the electrolyte membrane.

The membrane-electrode assembly may include a plurality of moisture discharge ports in a width direction of the electrolyte membrane.

The distance between the moisture discharge ports may be at least about 1 mm.

The moisture discharge port may have a diameter of about 1 mm to about 5 mm.

The moisture discharge port may be spaced apart from the first electrode by at least about 2 mm.

The membrane-electrode assembly may further include main gaskets disposed on the first sub-gasket and the second sub-gasket, and the main gaskets may include a plurality of gasket protrusions extending toward the first electrode and the second electrode.

The moisture discharge port may be disposed between the gasket protrusions.

Another embodiment of the present disclosure provides a method of manufacturing a membrane-electrode assembly, including preparing a stack including an electrolyte membrane having a first side and a second side, a first electrode disposed on the first side of the electrolyte membrane, and a second electrode disposed on the second side of the electrolyte membrane, attaching a first sub-gasket to the first side of the electrolyte membrane, forming a moisture discharge port through the first sub-gasket and the electrolyte membrane by perforating the first sub-gasket and the electrolyte membrane, and attaching a second sub-gasket to the second side of the electrolyte membrane.

A carrier film may be attached to the second side surface of the electrolyte membrane.

The method may further include removing the carrier film before attaching the second sub-gasket.

Here, forming the moisture discharge port may include perforating the first sub-gasket and the electrolyte membrane to a depth greater than or equal to a thickness of the first sub-gasket and the electrolyte membrane and less than or equal to a thickness of the first sub-gasket, the electrolyte membrane, and the carrier film.

Also, forming the moisture discharge port may include perforating the first sub-gasket and the electrolyte membrane by pressing the stack with the first sub-gasket attached thereto using a pair of roll presses.

The roll presses may include a first roll located on one surface of the electrolyte membrane and a second roll located on another surface of the electrolyte membrane, and the second roll may include a blade having a shape corresponding to a shape of the moisture discharge port.

The method may further include inspecting whether the moisture discharge port is formed using a vision camera before attaching the second sub-gasket after forming the moisture discharge port.

The method may further include disposing main gaskets on the first sub-gasket and the second sub-gasket.

In some embodiments, a membrane-electrode assembly comprises an electrolyte membrane having a first side and a second side, a first electrode disposed on the first side of the electrolyte membrane, a second electrode disposed on the second side of the electrolyte membrane, a first sub-gasket disposed on the first side of the electrolyte membrane and in contact with an edge of the first electrode, a second sub-gasket disposed on the second side of the electrolyte membrane and in contact with an edge of the second electrode, and a moisture discharge port extending through the first sub-gasket and the electrolyte membrane. The membrane-electrode assembly may include a plurality of moisture discharge ports in a width direction of the electrolyte membrane. The distance between these moisture discharge ports may be at least about 1 mm. The moisture discharge port may have a diameter of about 1 mm to about 5 mm. The moisture discharge port may be spaced apart from the first electrode by at least about 2 mm. The membrane-electrode assembly may further comprise main gaskets disposed on the first sub-gasket and the second sub-gasket, and these main gaskets may include a plurality of gasket protrusions extending toward the first electrode and the second electrode. The moisture discharge port may be disposed between the gasket protrusions.

In some embodiments, a method of manufacturing a membrane-electrode assembly includes preparing a stack comprising an electrolyte membrane having first and second sides, a first electrode on the first side of the electrolyte membrane, and a second electrode on the second side of the electrolyte membrane, attaching a first sub-gasket on the first side of the electrolyte membrane, forming a moisture discharge port through the first sub-gasket and the electrolyte membrane by perforating the first sub-gasket and the electrolyte membrane, and attaching a second sub-gasket to the second side of the electrolyte membrane. A carrier film may be attached to the second side of the electrolyte membrane, and the method may further include removing the carrier film before attaching the second sub-gasket. Forming the moisture discharge port may involve perforating the first sub-gasket and the electrolyte membrane to a depth greater than or equal to the thickness of the first sub-gasket and the electrolyte membrane and less than or equal to the thickness of the first sub-gasket, the electrolyte membrane, and the carrier film. A plurality of moisture discharge ports may be formed in a width direction of the electrolyte membrane, and a distance between them may be at least about 1 mm. The moisture discharge port may have a diameter of about 1 mm to about 5 mm, and it may be spaced apart from the first electrode by at least about 2 mm. Forming the moisture discharge port may involve pressing the stack with the first sub-gasket attached to the stack using a pair of roll presses. These roll presses may comprise a first roll located on one surface of the electrolyte membrane and a second roll located on another surface of the electrolyte membrane, and the second roll may include a blade having a shape corresponding to a shape of the moisture discharge port. The method may further include inspecting whether the moisture discharge port is formed using a vision camera before attaching the second sub-gasket and may also include disposing main gaskets on the first sub-gasket and the second sub-gasket, wherein the moisture discharge port may be disposed between gasket protrusions extending toward the first electrode and the second electrode.

As discussed, the method and system suitably include use of a controller or processer.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1 shows a membrane-electrode assembly according to some embodiments of the present disclosure;

FIG. 2 shows a cross-sectional view along line S-S′ of FIG. 1;

FIG. 3 shows an enlarged view of a moisture discharge port of FIG. 2;

FIG. 4 shows a process of manufacturing a membrane-electrode assembly according to some embodiments of the present disclosure;

FIG. 5 shows a first roll according to some embodiments of the present disclosure; and

FIG. 6 shows a second roll according to some embodiments of the present disclosure.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein and may be modified into different forms. These embodiments are provided to thoroughly explain the disclosure and to sufficiently transfer the spirit of the present disclosure to those skilled in the art.

The term “crossover” used herein refers to undesired migration of reactants (e.g., hydrogen or oxygen) through the electrolyte membrane from one electrode (anode or cathode) to the other, which can negatively affect fuel cell performance.

The term “moisture discharge port” used herein refers to an opening or passage that extends at least partially through a sub-gasket and the electrolyte membrane, allowing excess water or moisture to be removed from the membrane-electrode assembly.

The term “roll press” used herein refers to a device comprising one or more cylindrical rollers (rotating in opposite directions) that apply pressure to a sheet or stack, including any blades or raised portions on the rollers for perforation, embossing, or shaping operations.

The term “controller” used herein refers to any hardware or software module, including a processor and a memory, specifically programmed to execute instructions or algorithms for controlling or monitoring the manufacturing process, data collection, or other operations described in the present disclosure.

The term “polymer electrolyte membrane” used herein refers to a proton-conducting membrane made from polymers such as perfluorosulfonic acid-based polymers or hydrocarbon-based polymers, configured to facilitate the passage of protons while substantially blocking electrons and gases.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous and includes all values from the minimum value of said range to the maximum value thereof, unless otherwise indicated. Moreover, when such a range pertains to integer values, all integers including the minimum value to the maximum value are included, unless otherwise indicated.

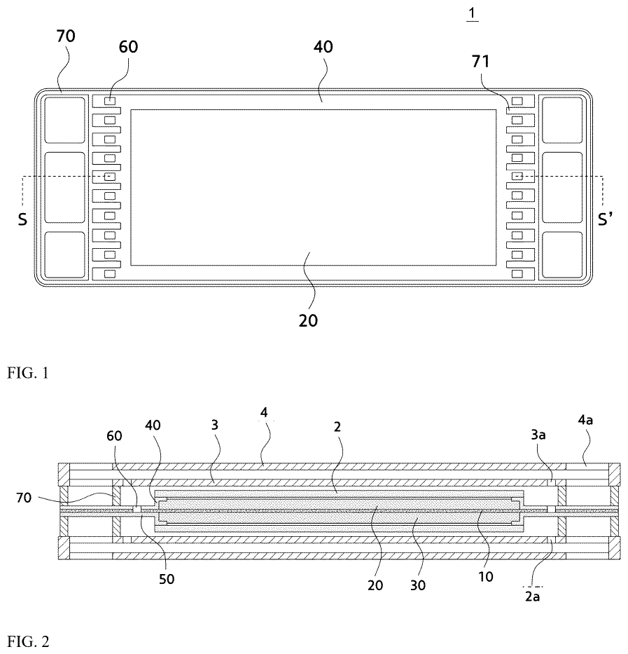

FIG. 1 shows a membrane-electrode assembly 1 according to the present disclosure. FIG. 2 shows a cross-sectional view along line S-S′ of FIG. 1. Specifically, FIG. 2 shows a cross-sectional view of a fuel cell in which a gas diffusion layer 2, a separator 3, and a current collector 4 are stacked on a membrane-electrode assembly 1.

Referring to FIGS. 1 and 2, the membrane-electrode assembly 1 may include an electrolyte membrane 10, a first electrode 20 disposed on one surface of the electrolyte membrane 10, a second electrode 30 disposed on another surface of the electrolyte membrane 10, a first sub-gasket 40 disposed on one surface of the electrolyte membrane 10 and in contact with an edge of the first electrode 20, and a second sub-gasket 50 disposed on the another surface of the electrolyte membrane 10 and in contact with an edge of the second electrode 30.

The electrolyte membrane 10 may include a polymer electrolyte membrane configured to allow protons to selectively pass therethrough. The electrolyte membrane 10 may include at least one selected from the group consisting of a perfluorosulfonic acid-based polymer, a hydrocarbon-based polymer, and combinations thereof.

The area of the electrolyte membrane 10 is not particularly limited and may be, for example, 10 cm² to 10 m². The thickness of the electrolyte membrane 10 is not particularly limited and may be, for example, 10 μm to 100 μm.

The electrolyte membrane 10 may include a central portion where the first electrode 20 and the second electrode 30 are disposed and an edge portion surrounding the central portion.

The first electrode 20 and the second electrode 30 may be supplied with reaction gases such as air, hydrogen, etc. to produce electrical energy by redox reaction of the reaction gases. The first electrode 20 and the second electrode 30 may have opposite polarities. For example, if the first electrode 20 is a cathode, the second electrode 30 may be an anode, or if the first electrode 20 is an anode, the second electrode 30 may be a cathode.

The first electrode 20 and the second electrode 30 may each include a catalyst, ionomer, etc. The catalyst may include a platinum catalyst, and the ionomer may include at least one selected from the group consisting of a perfluorosulfonic acid-based polymer, a hydrocarbon-based polymer, and combinations thereof.

The first electrode 20 and the second electrode 30 may each have a smaller area than the electrolyte membrane 10. The first electrode 20 and the second electrode 30 may each be disposed at the central portion of the electrolyte membrane 10.

The thickness of the first electrode 20 and the second electrode 30 is not particularly limited and may be, for example, 5 μm to 50 μm.

The gas diffusion layer 2 may be disposed on the first electrode 20 and the second electrode 30. The gas diffusion layer 2 may be in contact with the first sub-gasket 40 and the second sub-gasket 50. The gas diffusion layer 2 may be disposed on the first sub-gasket 40 and the second sub-gasket 50 so as not to be in direct contact with the first electrode 20 and the second electrode 30.

The gas diffusion layer 2 may be formed of a porous medium having high porosity so that the reaction gases and the product water may easily pass therethrough. For example, the gas diffusion layer 2 may include carbon fiber, polytetrafluoroethylene (PTFE), etc.

The first sub-gasket 40 and the second sub-gasket 50 may serve to impart physical rigidity to the electrolyte membrane 10. The first sub-gasket 40 and the second sub-gasket 50 may each include at least one selected from the group consisting of polyethylene terephthalate (PET), polyethylene naphthalate (PEN), polyethylene (PE), polypropylene (PP), and combinations thereof.

The first sub-gasket 40 may be disposed on one surface of the electrolyte membrane 10 to come into contact with the edge of the first electrode 20 and expose the first electrode 20 to the outside. From a planar perspective, the first sub-gasket 40 may be disposed to surround the first electrode 20.

The second sub-gasket 50 may be disposed on another surface of the electrolyte membrane 10 to come into contact with the edge of the second electrode 30 and expose the second electrode 30 to the outside. From a planar perspective, the second sub-gasket 50 may be disposed to surround the second electrode 30.

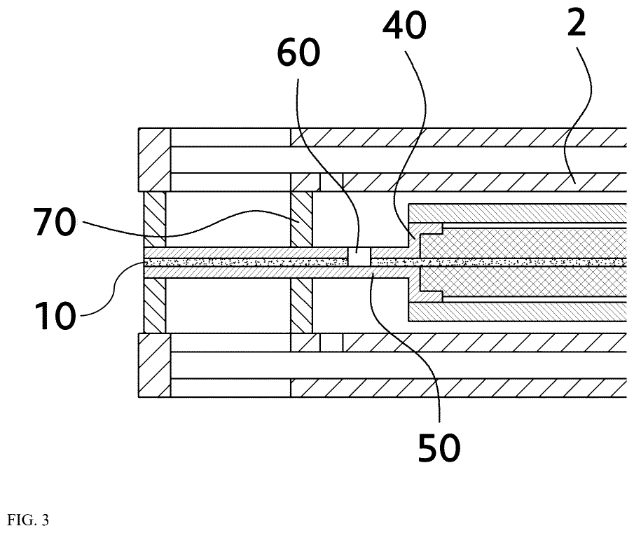

FIG. 3 shows an enlarged view of a moisture discharge port 60 of FIG. 2. The moisture discharge port 60 may be formed to penetrate the electrolyte membrane 10 and the first sub-gasket 40 at the edge portion of the electrolyte membrane 10. Accordingly, the moisture discharge port 60 may serve to discharge moisture generated from the electrolyte membrane 10 during electrochemical reaction to the outside of the membrane-electrode assembly 10. The moisture may be discharged to the outside of the fuel cell through a separator discharge port 3a and a current collector discharge port 4a.

In some embodiments, the present disclosure is characterized in that the moisture discharge port 60 is formed to penetrate not only the first sub-gasket 40 but also the electrolyte membrane 10. Accordingly, moisture generated from the electrolyte membrane 10 may be more effectively discharged to the outside. In addition, since the moisture discharge port 60 is formed to penetrate the electrolyte membrane 10, whether the moisture discharge port 60 is properly formed may be easily inspected compared to when penetrating only the first sub-gasket 40. For example, in cases in which a defective product in which the moisture discharge port 60 does not completely penetrate the first sub-gasket 40 is generated, defects in the moisture discharge port 60 cannot be detected because the attachment surface of the first sub-gasket 40 cannot be seen when the first sub-gasket 40 is attached to the electrolyte membrane 10.

In addition, in some embodiments, the present disclosure is characterized in that the moisture discharge port 60 is formed only in one side of the electrolyte membrane 10, not in both sides. If the moisture discharge port 60 is formed in the first sub-gasket 40 and the second sub-gasket 50, a problem with crossover of gas from the discharge port on one side to the discharge port on the other side due to gas diffusion may occur. Meanwhile, since the moisture discharge port 60 is formed only in the first sub-gasket 40 in certain embodiments of the present disclosure, the spacing of the moisture discharge port 60 may be maintained uniformly regardless of tolerance of the joint position of the first sub-gasket 40 and the second sub-gasket 50.

A plurality of moisture discharge ports 60 may be formed in the width direction of the electrolyte membrane 10. The distance between the moisture discharge ports 60 may be about 1 mm or more. The upper limit of the distance is not particularly limited and may be, for example, about 10 mm or less, about 5 mm or less, about 3 mm or less, or about 2 mm or less. If the distance is less than 1 mm, the portion between the moisture discharge ports 60 may be damaged during perforation.

The diameter of the moisture discharge port 60 may be about 1 mm to 5 mm. The diameter may indicate the longest distance from one point to another point on the outline of the moisture discharge port 60. If the diameter is less than 1 mm, it may be difficult for moisture to be discharged, whereas if it exceeds 5 mm, processability may deteriorate.

The moisture discharge port 60 may be spaced apart from the first electrode 20 by at least about 2 mm. The upper limit of the distance between the moisture discharge port 60 and the first electrode 20 is not particularly limited and may be, for example, about 10 mm or less, about 8 mm or less, or about 5 mm or less. If the distance between the moisture discharge port 60 and the first electrode 20 is less than 2 mm, defects may occur when the membrane-electrode assembly is operated for a long time.

The main gaskets 70 may be disposed between the first sub-gasket 40 and the second sub-gasket 50; and the separator 3 to support the separator 3. The main gaskets 70 may include a plurality of gasket protrusions 71 extending toward the first electrode 20 and the second electrode 30. The gasket protrusions 71 may extend in a direction perpendicular to the direction from the main gasket 70 toward the separator 3. From a planar perspective, a moisture discharge port 60 may be disposed between two adjacent gasket protrusions 71. Specifically, a plurality of moisture discharge ports 60 may be disposed between a plurality of gasket protrusions 71.

The separator 3 may include a flow field through which fuel or air flows to supply fuel or air toward the membrane-electrode assembly 1. In addition, the separator 3 may serve to discharge products such as water, etc. generated after electrochemical reaction to the outside.

The current collector 4 may be disposed on the separator 3. The current collector 4 may be provided on each of the first sub-gasket 40 and the second sub-gasket 50. The current collector 4 may be provided with manifolds to supply fuel or air to the membrane-electrode assembly 1.

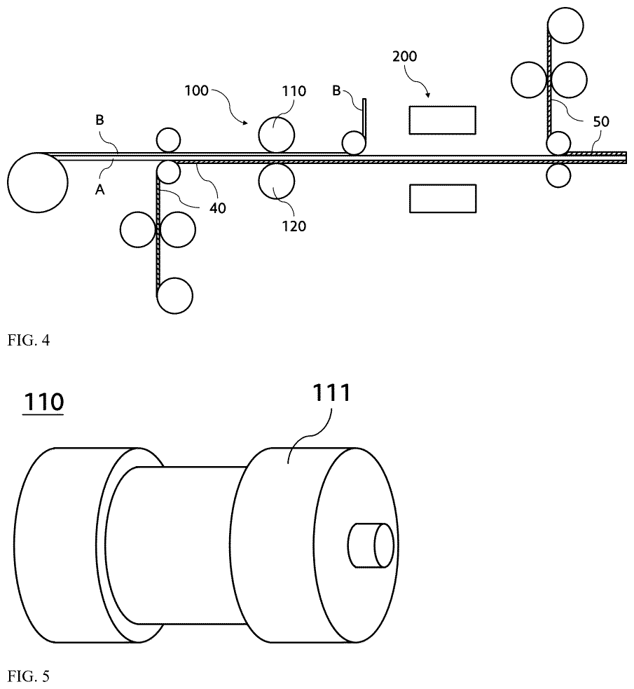

FIG. 4 shows a process of manufacturing a membrane-electrode assembly according to the present disclosure. The method of manufacturing a membrane-electrode assembly may include preparing a stack A including an electrolyte membrane, a first electrode disposed on one surface of the electrolyte membrane, and a second electrode disposed on another surface of the electrolyte membrane, attaching a first sub-gasket 40 to one surface of the stack (specifically one surface of the electrolyte membrane), forming moisture discharge ports penetrating the first sub-gasket 40 and the electrolyte membrane by perforating the first sub-gasket 40 and the electrolyte membrane, and attaching a second sub-gasket 50 to another surface of the stack A.

The stack A may include a CCM (catalyst coated membrane) in which electrodes are formed on an electrolyte membrane.

A carrier film B may be attached to another surface of the stack A. The carrier film B may be used to increase processability in the process of moving the stack A from roll to roll. The carrier film B may include polyethylene terephthalate (PET), polyethylene naphthalate (PEN), polyoxymethylene (POM), etc.

The first sub-gasket 40 may be attached to one surface of the stack A to which the carrier film B is not attached among both surfaces of the stack A.

The moisture discharge ports may be formed by perforating the first sub-gasket 40 and the electrolyte membrane by pressing the stack A with the first sub-gasket 40 attached thereto using a roll press 100. The perforation depth is not particularly limited and may be set to a depth sufficient to completely penetrate the first sub-gasket 40 and the electrolyte membrane. Specifically, perforation may be performed to a depth greater than or equal to the thickness of the first sub-gasket 40 and the electrolyte membrane and less than or equal to the thickness of the first sub-gasket 40, the electrolyte membrane, and the carrier film B.

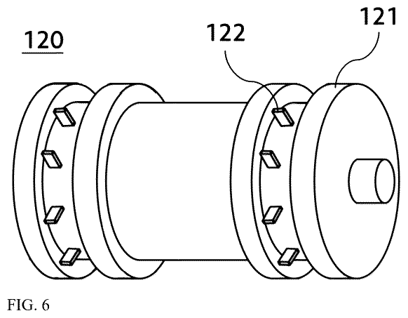

The roll press 100 may include a first roll 110 located on the carrier film B side and a second roll 120 located on the first sub-gasket 40 side. FIG. 5 shows the first roll 110 according to the present disclosure. FIG. 6 shows the second roll 120 according to the present disclosure. Referring to FIGS. 5 and 6, the first roll 110 and the second roll 120 may have a dumbbell shape in which the edges 111, 121 in the width direction are thicker than the middle portion. The second roll 120 may include blades 122 at the edges 121 thereof. The edges 111 of the first roll 110 and the edges 121 of the second roll 120 may serve to fix the stack A and the first sub-gasket 40, and the blades 122 may serve to perforate the first sub-gasket 40 and the electrolyte membrane to form moisture discharge ports 60. The number, position, spacing, etc. of the blades 122 may be appropriately adjusted depending on the desired specifications of the moisture discharge ports 60. The moisture discharge ports 60 are as described above and a description thereof is omitted below. In addition, the method of forming the moisture discharge ports 60 is not limited thereto, and the moisture discharge ports 60 may be formed using a method such as a laser, punching, etc.

After forming the moisture discharge ports 60, the carrier film B may be removed.

The manufacturing method may further include inspecting whether the moisture discharge ports 60 are formed using a vision camera 200 after removing the carrier film B. The vision camera 200 may be disposed above both surfaces of the stack A. By capturing and processing an image of the stack A with the vision camera 200, and using a defect detection algorithm, it is possible to identify color difference, size and/or shape inconsistency, etc. to determine whether the moisture discharge ports 60 are properly formed.

A membrane-electrode assembly may be obtained by attaching the second sub-gasket 50 to another surface of the stack A that has completed inspection. Meanwhile, the manufacturing method may further include disposing main gaskets on the first sub-gasket 40 and the second sub-gasket 50. As such, the main gaskets may be attached so that the moisture discharge ports are disposed between gasket protrusions of the main gaskets.

As is apparent from the foregoing, according to the present disclosure, a membrane-electrode assembly capable of preventing defects caused by blistering by virtue of efficient discharge of moisture and a method of manufacturing the same can be provided.

According to the present disclosure, a membrane-electrode assembly capable of easily confirming whether the structure of a final product is properly formed and a method of manufacturing the same can be provided.

According to the present disclosure, a membrane-electrode assembly capable of preventing crossover and a method of manufacturing the same can be provided.

The effects of the present disclosure are not limited to the foregoing. It should be understood that the effects of the present disclosure include all effects that can be inferred from the description of the present disclosure.

Although specific embodiments of the present disclosure have been described with reference to the attached drawings, those skilled in the art will appreciate that the present disclosure may be embodied in other specific forms without changing the technical spirit or essential features thereof. Thus, the embodiments described above should be understood to be non-limiting and illustrative in every way.

What is claimed is:

1. A membrane-electrode assembly comprising:
an electrolyte membrane having a first side and a second side;
a first electrode disposed on the first side of the electrolyte membrane;
a second electrode disposed on the second side of the electrolyte membrane;
a first sub-gasket disposed on the first side of the electrolyte membrane and in contact with an edge of the first electrode;
a second sub-gasket disposed on the second side of the electrolyte membrane and in contact with an edge of the second electrode; and
a moisture discharge port extending through the first sub-gasket and the electrolyte membrane.

2. The membrane-electrode assembly of claim 1, wherein the membrane-electrode assembly comprises a plurality of moisture discharge ports in a width direction of the electrolyte membrane.

3. The membrane-electrode assembly of claim 2, wherein a distance between the moisture discharge ports is at least about 1 mm.

4. The membrane-electrode assembly of claim 1, wherein the moisture discharge port has a diameter of about 1 mm to about 5 mm.

5. The membrane-electrode assembly of claim 1, wherein the moisture discharge port is spaced apart from the first electrode by at least about 2 mm.

6. The membrane-electrode assembly of claim 1, wherein the membrane-electrode assembly further comprises main gaskets disposed on the first sub-gasket and the second sub-gasket, wherein the main gaskets comprise a plurality of gasket protrusions extending toward the first electrode and the second electrode.

7. The membrane-electrode assembly of claim 6, wherein the moisture discharge port is disposed between the gasket protrusions.

8. A method of manufacturing a membrane-electrode assembly, comprising:
preparing a stack comprising an electrolyte membrane having first and second sides, a first electrode on the first side of the electrolyte membrane, and a second electrode on the second side of the electrolyte membrane;
attaching a first sub-gasket on the first side of the electrolyte membrane;
forming a moisture discharge port through the first sub-gasket and the electrolyte membrane by perforating the first sub-gasket and the electrolyte membrane; and
attaching a second sub-gasket to the second side of the electrolyte membrane.

9. The method of claim 8, wherein a carrier film is attached to the second side of the electrolyte membrane.

10. The method of claim 9, wherein the method further comprises removing the carrier film before attaching the second sub-gasket.

11. The method of claim 8, wherein forming the moisture discharge port comprises perforating the first sub-gasket and the electrolyte membrane to a depth greater than or equal to a thickness of the first sub-gasket and the electrolyte membrane and less than or equal to a thickness of the first sub-gasket, the electrolyte membrane, and the carrier film.

12. The method of claim 8, wherein a plurality of moisture discharge ports is formed in a width direction of the electrolyte membrane.

13. The method of claim 12, wherein a distance between the moisture discharge ports is at least about 1 mm.

14. The method of claim 8, wherein the moisture discharge port has a diameter of about 1 mm to about 5 mm.

15. The method of claim 8, wherein the moisture discharge port is spaced apart from the first electrode by at least about 2 mm.

16. The method of claim 8, wherein forming the moisture discharge port comprises perforating the first sub-gasket and the electrolyte membrane by pressing the stack with the first sub-gasket attached to the stack using a pair of roll presses.

17. The method of claim 16, wherein the roll presses comprise a first roll located on one surface of the electrolyte membrane and a second roll located on another surface of the electrolyte membrane, and the second roll comprises a blade having a shape corresponding to a shape of the moisture discharge port.

18. The method of claim 8, wherein the method further comprises inspecting whether the moisture discharge port is formed using a vision camera before attaching the second sub-gasket after forming the moisture discharge port.

19. The method of claim 8, wherein the method further comprises disposing main gaskets on the first sub-gasket and the second sub-gasket, wherein the main gaskets comprise a plurality of gasket protrusions extending toward the first electrode and the second electrode.

20. The method of claim 19, wherein the moisture discharge port is disposed between the gasket protrusions.
